(19) United States
(12) Patent Application Publication
(10) Pub. No.: US 2024/0412429 A1
(43) Pub. Date: Dec. 12, 2024

(54) MULTI-ATTRIBUTE FACE EDITING

(71) Applicant: ADOBE INC., SAN JOSE, CA (US)

(72) Inventors: Wei-An Lin, San Jose, CA (US); Hui Qu, Santa Clara, CA (US); Siavash Khodadadeh, Mountain View, CA (US); Kevin Duarte, San Jose, CA (US); Surabhi Sinha, San Jose, CA (US); Ratheesh Kalarot, San Jose, CA (US); Shabnam Ghadar, Menlo Park, CA (US)

(21) Appl. No.: 18/332,163

(22) Filed: Jun. 9, 2023

(51) Int. Cl. G06T 11/60; G06V 10/82; G06V 40/16

(52) U.S. Cl. CPC G06T 11/60; G06V 10/82; G06V 40/169

(57) ABSTRACT

Systems and methods for editing multiple attributes of an image are described. Embodiments are configured to receive input comprising an image of a face and a target value of an attribute of the face to be modified; encode the image using an encoder of an image generation neural network to obtain an image embedding; and generate a modified image of the face having the target value of the attribute based on the image embedding using a decoder of the image generation neural network. The image generation neural network is trained using a plurality of training images generated by a separate training image generation neural network, and the plurality of training images include a first synthetic image having a first value of the attribute and a second synthetic image depicting a same face as the first synthetic image with a second value of the attribute.

### BACKGROUND

The following relates to image processing, and more specifically to image editing through generative machine learning. Image processing refers to the use of a computer to process a digital image using an algorithm or processing network. Examples of image editing include image enhancement, brightness and contrast adjustments, and color grading. Some examples of image editing include using generative models to create new image data to paste over original data, thereby changing certain attributes about an image. For example, recent learning (ML) models have been developed that are capable of editing facial attributes of a subject such as smile, age, hair style, and the like.

Generative Adversarial Networks (GANs) such as StyleGAN can utilize image encodings in a latent space. However, editing vectors in the latent space does not always enable continuous editing of an attribute's intensity. Furthermore, when such models reconstruct an image with a changed attribute, other aspects of the image can be changed as well. This can cause noticeable distortion. Additionally, some models do not allow for editing of multiple attributes at once. There is a need in the art for models that can change multiple attributes of an image, provide continuous editing capabilities, and preserve the identity of subjects in the images.

### SUMMARY

Embodiments of an image processing apparatus are described herein. Embodiments include an image generation neural network configured adjust an attribute of an image with continuous control. Some embodiments are further configured to edit multiple attributes of an image during a single transformation. The image generation neural network is trained on training data generated by a training image generation neural network. The training data includes synthetic images that are based on original images, with edits made to one or more attributes and varying in intensity. In some examples, the image generation neural network is conditioned with an edit vector which indicates the attributes and the intensity of the edits. The edit vector directs a decoder of the image generation neural network to generate an edited image based on the edit vector and an input image.

A method, apparatus, non-transitory computer readable medium, and system for facial attribute editing are described. One or more aspects of the method, apparatus, non-transitory computer readable medium, and system include receiving input comprising an image of a face and a target value of an attribute of the face to be modified; encoding the image using an encoder of an image generation neural network to obtain an image embedding; and generating a modified image of the face having the target value of the attribute based on the image embedding using a decoder of the image generation neural network, wherein the image generation neural network is trained using a plurality of training images generated by a training image generation neural network, and wherein the plurality of training images includes a first synthetic image having a first value of the attribute and a second synthetic image depicting a same face as the first synthetic image with a second value of the attribute.

A method, apparatus, non-transitory computer readable medium, and system for facial attribute editing are described. One or more aspects of the method, apparatus, non-transitory computer readable medium, and system include generating a plurality of training images using a training image generation neural network, wherein the plurality of training images includes a first synthetic image having a first value of an attribute and a second synthetic image with a second value of the attribute and training an image generation neural network to modify face images based on a target value of the attribute using the plurality of training images.

An apparatus, system, and method for facial attribute editing are described. One or more aspects of the apparatus, system, and method include at least one processor; at least one memory including instructions executable by the at least one processor; and an image generation neural network configured to generate a modified image of a face having a target value of an attribute based on an image embedding, wherein the image generation neural network is trained using a plurality of training images including a first synthetic image having a first value of the attribute and a second synthetic image depicting a same face as the first synthetic image with a second value of the attribute.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a training image generation neural network at inference time according to aspects of the present disclosure.

FIG. 4 shows an example of an image generation neural network at inference time according to aspects of the present disclosure.

FIG. 5 shows an example of an image generation neural network utilizing cached tensors according to aspects of the present disclosure.

FIG. 6 shows an example of a method for editing image attributes according to aspects of the present disclosure.

FIG. 7 shows an example of a method for generating modified images according to aspects of the present disclosure.

FIG. 8 shows an example of a training image generation neural network during a first training phase according to aspects of the present disclosure.

FIG. 9 shows an example of training data generated by a training image generation neural network according to aspects of the present disclosure.

FIG. 10 shows an example of a method for generating synthetic images according to aspects of the present disclosure.

FIG. 11 shows an example of an image generation neural network during a second training phase according to aspects of the present disclosure.

FIG. 12 shows an example of a computing device according to aspects of the present disclosure.

### DETAILED DESCRIPTION

Realistically manipulating the appearance of faces in images through the use of computer software is useful for modern social media and creative workflows. To create high-quality and believable images, the models used in the software generates edits that retain the original textures and subject identity from the input image. Machine learning (ML) models such as StyleGAN have been applied to this task.

Generative Adversarial Networks (GANs) are a type of deep learning model that consists of two neural networks: a generator and a discriminator. The generator creates new samples that resemble the input data, while the discriminator learns to differentiate between the generated samples and the real ones. StyleGAN is a specific type of GAN that uses an architecture that allows for high-quality image synthesis. The model is trained on a large dataset of images and learns to generate new images that are similar to the training data.

Users can edit facial attributes using StyleGAN by conditioning the generator with a guide which adjusts parameters of the generator to produce edits such as changes to age, gender, facial expressions, and others. The generator is a type of decoder which processes a style-space embedding of an input image. Embedding the input image into the style space is referred to as an “inversion” of the input image. However, achieving a highly editable inversion of an input image often leads to the reconstruction image losing fine details or identity (e.g., caused by distortion) with respect to the input image. There exists a “reconstruction-editability” tradeoff between the ability to faithfully reconstruct the original image and the ability to edit the reconstructed image. For example, a model may successfully reconstruct the input image with high fidelity, but the resulting image is difficult to edit without degrading quality or losing the subject's identity. Conversely, a model may allow for easy editing of the generated image, but the original image's fine details and textures are lost during the inversion process. Accordingly, the conventional StyleGAN model does not allow for highly editable versions of input images. This architecture does succeed in generating editable variations of its underlying data distribution (i.e., from the knowledge gathered during its training), e.g., not based on an input image, which makes it suitable for generating synthetic images.

By contrast, embodiments of the present disclosure include an image generation neural network that is configured to edit multiple attributes of an input image simultaneously with continuous control while preserving subject identity and fine textures. In an example, the image generation is configured by adjusting its parameters during a training process that includes training data groups, where each group includes an unedited image, an edited image, and a vector representing the edits made to the unedited image. In some cases, the training data groups are generated by a training image generation neural network. Some embodiments of the training image generation neural network include a modified StyleGAN architecture. Some embodiments of the image generation neural network include a conditional GAN architecture, such as “guided CoModGAN”.

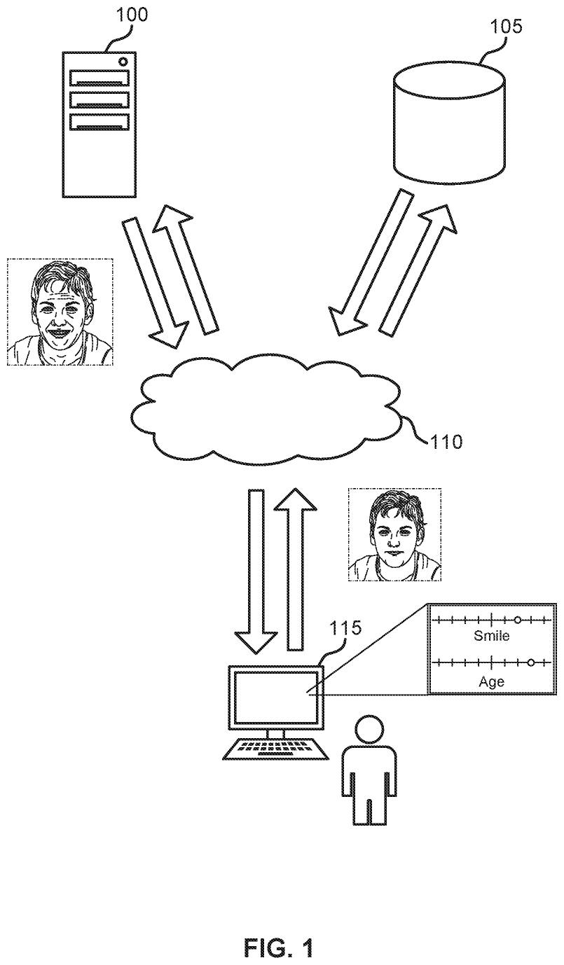

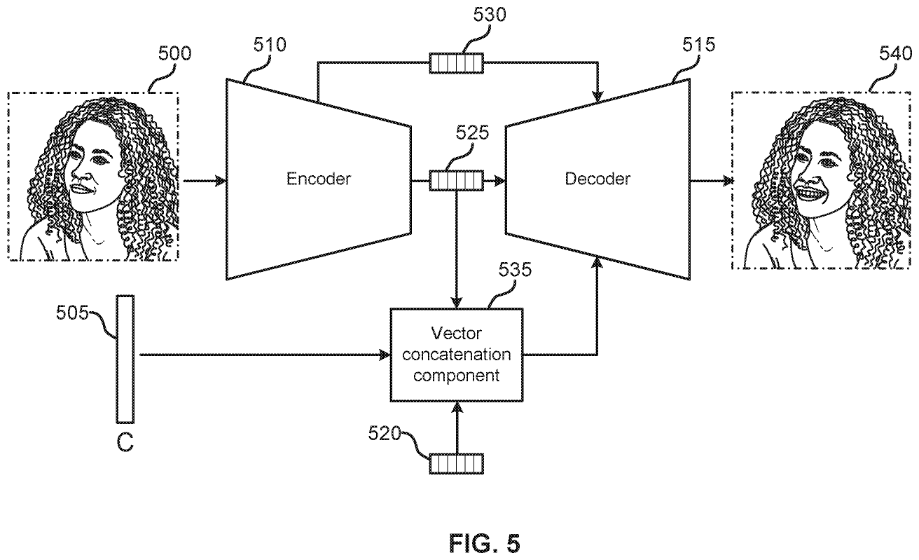

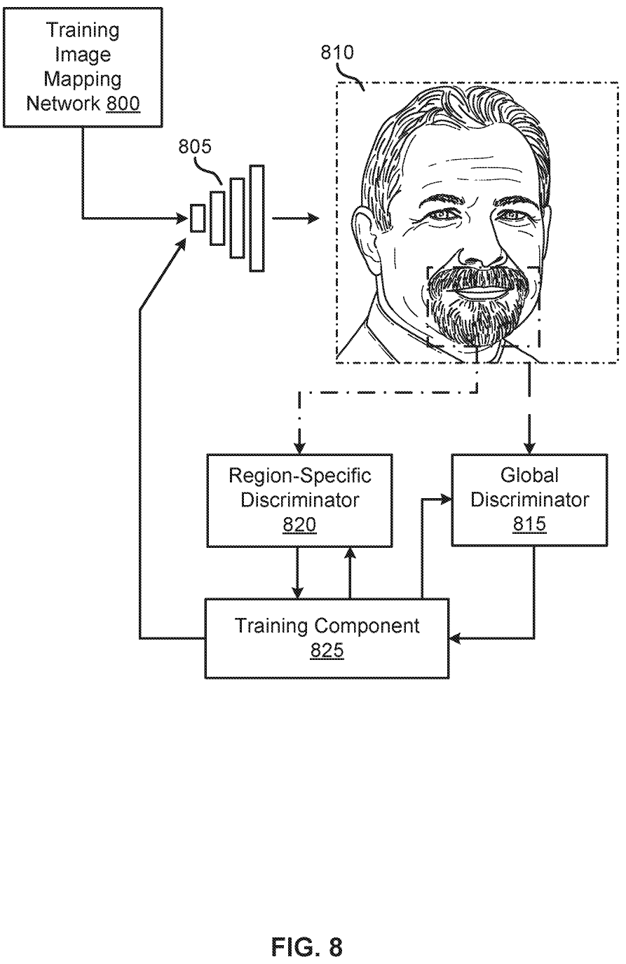

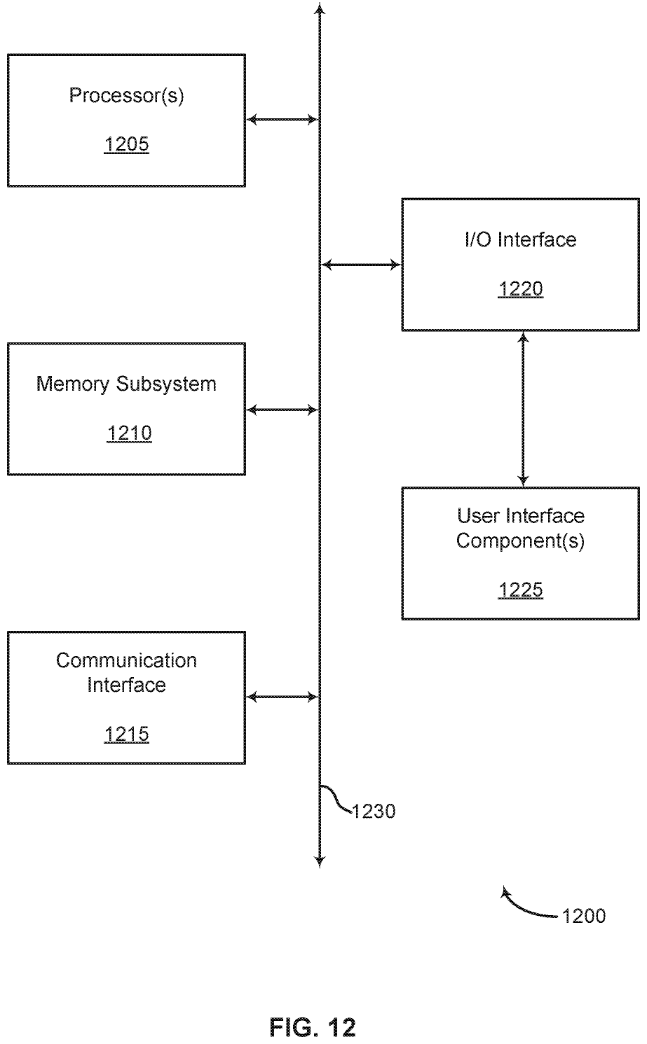

An image processing system is described with reference to FIGS. 1-5. Methods for multi-attribute editing of images are described with reference to FIGS. 5-7. Training methods, such as methods for generating training data for the image processing system, are described with reference to FIGS. 8-11. A computing device that may be used to implement the image processing system is described with reference to FIG. 12.

### Image Processing System

An apparatus for facial attribute editing is described. One or more aspects of the apparatus include at least one processor; at least one memory including instructions executable by the at least one processor; and an image generation neural network configured to generate a modified image of a face having a target value of an attribute based on an image embedding, wherein the image generation neural network is trained using a plurality of training images including a first synthetic image having a first value of the attribute and a second synthetic image depicting a same face as the first synthetic image with a second value of the attribute. In some aspects, the image generation neural network includes an encoder and a decoder, and wherein an intermediate layer of the encoder provides input to an intermediate layer of the decoder.

Some examples of the apparatus, system, and method further include a training image generation neural network configured to generate the plurality of training images. In some aspects, the training image generation neural network comprises a global discriminator and a region-specific discriminator. Additional detail regarding the training process, as well as the region-specific discriminator, will be provided with reference to FIG. 8-11.

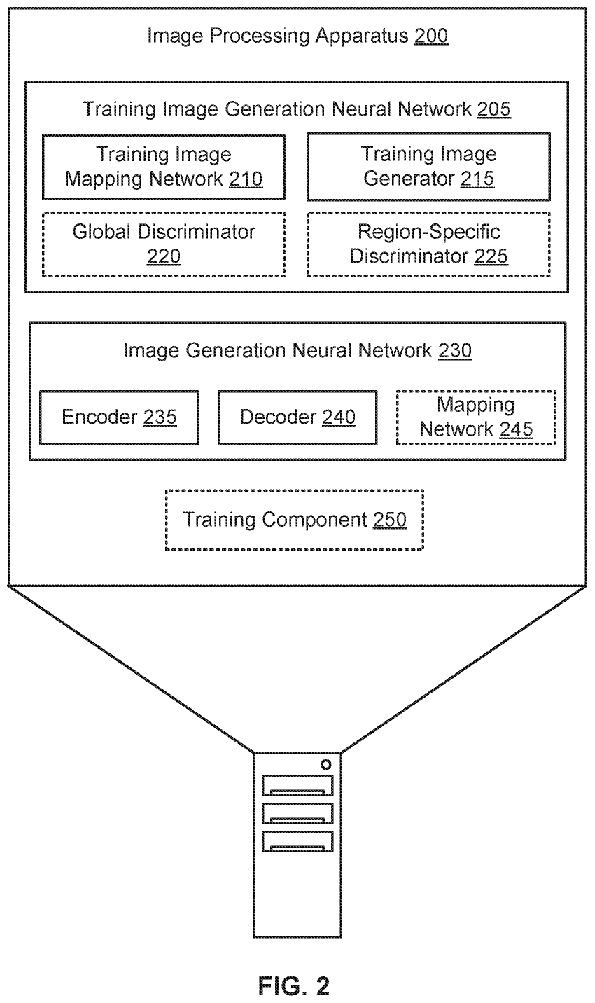

FIG. 1 shows an example of an image processing system according to aspects of the present disclosure. The example shown includes image processing apparatus 100, database 105, network 110, and user interface 115. Image processing apparatus 100 is an example of, or includes aspects of, the corresponding element described with reference to FIG. 2.

In an example use case, a user identifies an image for editing as well as desired edits to attributes of the image. The user interacts with the system using user interface 115, which includes a graphical user interface (GUI) that may include slider controls. The image and the edit information are sent to image processing apparatus 100 through network 110. In some cases, image processing apparatus 100 includes an image generation neural network and a training image generation neural network. Various parameters and cached tensors of both models may be stored in database 105 and used during the process. The image generation neural network processes the image and the edit information and produces a modified image containing the desired edits. The modified image is then sent back to the user. In some cases, the user is prompted via user interface 115 to regenerate the image or provide additional edits.

Embodiments of image processing apparatus 100 or portions of image processing apparatus 100 can be implemented on a server. A server provides one or more functions to users linked by way of one or more of the various networks such as network 110. In some cases, the server includes a single microprocessor board, which includes a microprocessor responsible for controlling all aspects of the server. In some cases, a server uses microprocessor and protocols to exchange data with other devices/users on one or more of the networks 110 via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus. The present embodiments are not implemented thereto, however, and one or more components of image processing apparatus 100 may be implemented on a user device such as a personal computer or a mobile phone.

Various data used by the system can be stored on a database such as database 105. For example, parameters and training data included in the generative neural networks within image processing apparatus 100 may be stored on database 105. A database is an organized collection of data. For example, a database stores data in a specified format known as a schema. In some cases, database 105 includes data storage, as well as a server to manage disbursement of data and content. A database may be structured as a single database, a distributed database, multiple distributed databases, or an emergency backup database. In some cases, a database controller may manage data storage and processing in database 105. In some cases, a user interacts with the database controller. In other cases, the database controller may operate automatically without user interaction.

Network 110 facilitates the transfer of information between image processing apparatus 100, database 105, and user interface 115. Network 110 can be referred to as a “cloud.” A cloud is a computer network configured to provide on-demand availability of computer system resources, such as data storage and computing power. In some examples, the cloud provides resources without active management by the user. The term cloud is sometimes used to describe data centers available to multiple users over the Internet. Some large cloud networks have functions distributed over multiple locations from central servers. A server is designated an edge server if it has a direct or close connection to a user. In some cases, a cloud is limited to a single organization. In other examples, the cloud is available to multiple organizations. In one example, a cloud includes a multi-layer communications network comprising multiple edge routers and core routers. In another example, a cloud is based on a local collection of switches in a single physical location.

A user interface enables a user to interact with a device. For example, user interface 115 may be configured to receive commands from and present content to a user. In some examples, the user interface prompts the user to select an image for editing, as well as select various attributes to edit such as through the use of slider controls. In some embodiments, user interface includes an audio device, such as an external speaker system, an external display device such as a display screen, or an input device (e.g., remote control device interfaced with user interface 115 directly or through an IO controller module). In some cases, user interface 115 includes a graphical user interface (GUI).

According to some aspects, image processing apparatus 100 receives input including an image of a face and a target value of an attribute of the face to be modified. In some examples, image processing apparatus 100 generates an edit vector that indicates the target value of the attribute, where the modified image is generated based on the edit vector. In some aspects, the edit vector indicates target values for a set of attributes of the face. In some examples, image processing apparatus 100 receives a subsequent input including an additional target value for an additional attribute to be modified.

FIG. 2 shows an example of an image processing apparatus 200 according to aspects of the present disclosure. The example shown includes image processing apparatus 200, training image generation neural network 205, image generation neural network 230, and training component 250. Image processing apparatus 200 is an example of, or includes aspects of, the corresponding element described with reference to FIG. 1.

In one aspect, training image generation neural network 205 includes training image mapping network 210, training image generator 215, global discriminator 220, and region- specific discriminator 225. In one aspect, image generation neural network 230 includes encoder 235, decoder 240, and mapping network 245.

Embodiments of image processing apparatus 200 include several components. The term ‘component’ is used to partition the functionality enabled by the processor(s) and the executable instructions included in the computing device used to implement image processing apparatus 200 (such as the computing device described with reference to FIG. 12). The partitions may be implemented physically, such as through the use of separate circuits or processors for each component, or may be implemented logically via the architecture of the code executable by the processors.

Embodiments of training image generation neural network 205 and image generation neural network 230 include models that are based on a GAN. A GAN is an ANN in which two neural networks (e.g., a generator and a discriminator) are trained based on a contest with each other. For example, the generator learns to generate a candidate by mapping information from a latent space to a data distribution of interest, while the discriminator distinguishes the candidate produced by the generator from a true data distribution of the data distribution of interest. The generator's training objective is to increase an error rate of the discriminator by producing novel candidates that the discriminator classifies as “real” (e.g., belonging to the true data distribution).

Therefore, given a training set, the GAN learns to generate new data with similar properties as the training set. For example, a GAN trained on photographs can generate new images that look authentic to a human observer. GANs may be used in conjunction with supervised learning, semi-supervised learning, unsupervised learning, and reinforcement learning.

One or more constituent components (for example, layers) of training image generation neural network 205 and image generation neural network 230 include a convolutional neural network (CNN). A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

Training image generation neural network 205 is configured to generate training data groups, which include synthetic images that include edits to a base image. Embodiments of training image generation neural network 205 include a modified StyleGAN architecture. In some aspects, the training image generation neural network 205 includes a global discriminator 220 and a region-specific discriminator 225.

According to some aspects, training image generation neural network 205 generates a set of training images, where the set of training images includes a first synthetic image having a first value of an attribute and a second synthetic image with a second value of the attribute. In some examples, training image generation neural network 205 generates a third synthetic image based on the third modified latent vector. In some aspects, the first value of the attribute includes a positive value and the second value of the attribute includes a negative value. In some aspects, the set of training images includes additional synthetic images generated based on a set of additional attributes. Additional detail regarding training data generation will be provided with reference to FIGS. 8-11.

Some GAN generative models include a mapping network that maps a noise vector from a lower dimensional space to a higher dimensional space to be used as input to a generator network. This mapping is typically learned using a feedforward neural network with multiple layers. The goal of the mapping network is to find a smooth and continuous mapping between the random noise vector and the latent space representation, such that small changes in the input noise vector result in smooth and meaningful changes in the generated output. This helps ensure that the generator network can produce high-quality images or other types of data that are consistent with the underlying data distribution provided during training.

Training image mapping network 210 is configured to map a noise vector to a latent vector as input to a generator, such as training image generator 215. According to some aspects, training image mapping network 210 generates a latent vector for the training image generation neural network 205.

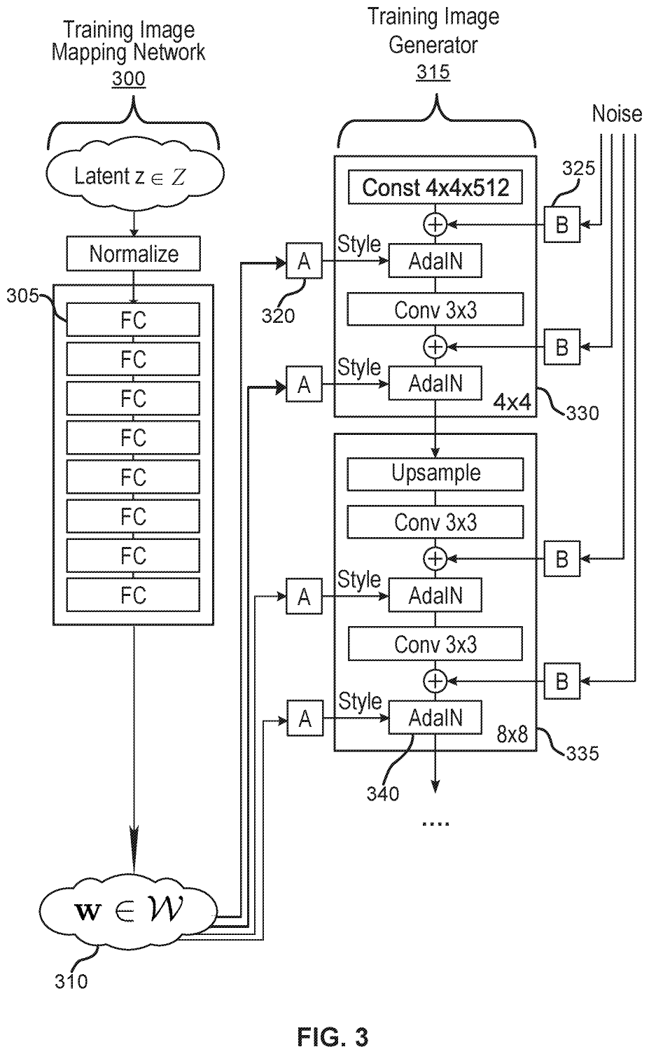

In some examples, training image mapping network 210 generates a first modified latent vector based on the latent vector and the first value of an attribute, where the first synthetic image in a training data group is generated based on the first modified latent vector. In some examples, training image mapping network 210 generates a second modified latent vector based on the latent vector and a second value of the attribute, where the second synthetic image in the training group is generated based on the second modified latent vector. In some examples, training image mapping network 210 generates a third modified latent vector based on the latent vector and a third value of the attribute. In some examples, training image mapping network 210 multiplies a modification basis vector by the first value of the attribute to obtain a latent modification vector, where the first modified latent vector is based on the latent modification vector. Training image mapping network 210 is an example of, or includes aspects of, the corresponding element described with reference to FIGS. 3 and 8.

GAN models include a generator and a discriminator. The generator produces synthetic images similar to the training data. In some cases, the discriminator is discarded after training, and the generator's output images are used during inference time. Training image generator 215 is configured to produce synthetic images as training images for image generation neural network 230. In some embodiments, training image generator 215 is trained during a first training phase to learn to predict synthetic images that are used by image generation neural network 230 during a second training phase. In some examples, the image generation neural network 230 is trained to generate output images with multiple edited attributes during the second training phase. Training image generator 215 is an example of, or includes aspects of, the corresponding element described with reference to FIGS. 3 and 8.

Embodiments of training image generation neural network 205 include a global discriminator 220 and a region-specific discriminator 225. In some cases, both discriminators are discarded after a first training phase. In an example, global discriminator 220 evaluates outputs from training image generator 215 during a first training phase and classifies the outputs as real or synthetic. The discriminator is trained to minimize its classification error by adjusting its weights and biases. At the same time, the generator is trained to fool the discriminator by producing fake data that is as realistic as possible. The generator receives feedback from the discriminator in the form of its probability score, and adjusts its parameters to increase the likelihood of producing realistic data that can fool the discriminator.

Region-specific discriminator 225 is applied to a subset of the data output by training image generator 215 during the first training phase. In some embodiments, region-specific discriminator 225 is applied to an area corresponding to a mouth of a face and classifies the data within the area as real or synthetic. In some cases, region-specific discriminator 225 uses computer vision techniques to identify a bounding box of the area, such as an area corresponding to a mouth of a face. In some cases, region-specific discriminator 225 evaluates the same area for every generator output, based on an assumption that the area corresponds to the same region of the face for each output. Global discriminator 220 is an example of, or includes aspects of, the corresponding element described with reference to FIG. 8. Region-specific discriminator 225 is an example of, or includes aspects of, the corresponding element described with reference to FIG. 8.

Image generation neural network 230 is configured to generate images based on an input image and an edit vector. In one aspect, image generation neural network 230 includes encoder 235, decoder 240, and mapping network 245. In some embodiments, image generation neural network 230 is based on a GAN architecture, and the decoder 240 generates output images by applying learned transformations to a style space embedding similar to the process of training image generator 215. Some embodiments of image generation neural network 230 are based on a guided CoModGAN architecture. However, embodiments of image generation neural network 230 are not limited to these examples. For example, some embodiments of image generation neural network 230 can be implemented in any trainable encoder-decoder type model. In some examples, for instance, image generation neural network 230 does not include mapping network 245 or a cached tensor produced by a mapping network. In such examples, image generation neural network 230 generates images based on an input image and an edit vector only, and not on a latent vector produced by a mapping network.

In an example, a user provides an image of a face, and an a desired edit of an attribute of the face. According to some aspects, encoder 235 encodes the image using an encoder 235 of an image generation neural network 230 to obtain an image embedding. In some examples, encoder 235 provides an intermediate image embedding from the encoder 235 as input to an intermediate layer of the decoder 240. In some examples, encoder 235 caches the image embedding.

According to some aspects, image generation neural network 230 generates a modified image of the face having a target value of the attribute based on the image embedding using a decoder 240 of the image generation neural network 230, where the image generation neural network 230 is trained using a set of training images generated by a training image generation neural network 205, and where the set of training images includes a first synthetic image having a first value of the attribute and a second synthetic image depicting a same face as the first synthetic image with a second value of the attribute. In some aspects, the modified image preserves a texture of the image that is unrelated to the attribute. In some aspects, the modified image preserves an identity of the face. In some examples, image generation neural network 230 generates a subsequent modified image based on the cached image embedding and the additional target value.

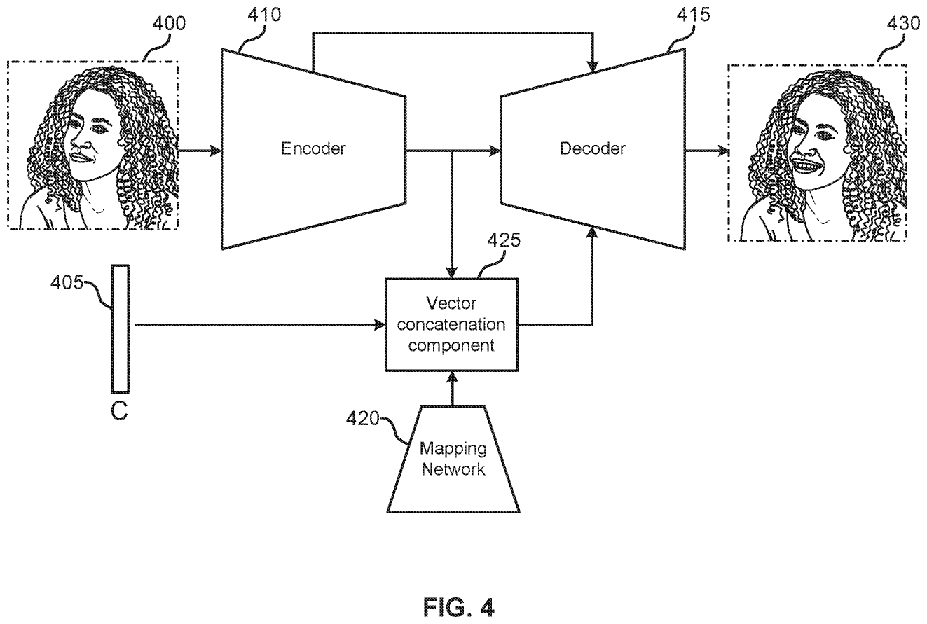

Encoder 235 is an example of, or includes aspects of, the corresponding element described with reference to FIGS. 4, 5, and 11. Decoder 240 is an example of, or includes aspects of, the corresponding element described with reference to FIGS. 4, 5, and 11.

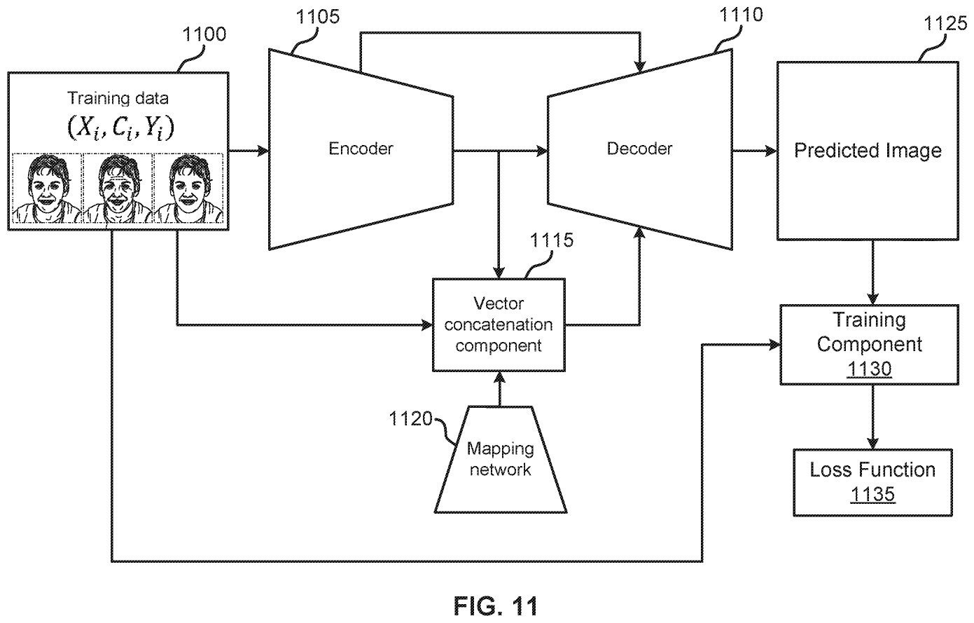

According to some aspects, mapping network 245 generates a noise vector, where the modified image is generated based on the noise vector. Some embodiments of image generation neural network 230 do not utilize the noise vector, and generate images based on an image embedding from encoder 235 and an edit vector only. In some cases, mapping network 245 generates a fixed vector in a W space (e.g., a style space), and this vector is cached once and used for inference. For example, mapping network 245 may be trained, generate a fixed vector in an initialization phase, and then be discarded during an inference phase of image generation neural network 230. Mapping network 245 is an example of, or includes aspects of, the corresponding element described with reference to FIGS. 4 and 11.

Training component 250 is configured to compute loss functions for both training image generation neural network 205 and image generation neural network 230, and update the parameters of both models according to the loss function. In some examples, training component 250 updates parameters of training image generation neural network 205 during a first training phase, and updates parameters of image generation neural network 230 during a second training phase.

According to some aspects, training component 250 trains an image generation neural network 230 to modify face images based on a target value of the attribute using the set of training images. In some examples, training component 250 trains the training image generation neural network 205 based on a global discriminator 220 and a region-specific discriminator 225. In some examples, training component 250 compares a modified image generated by image generation neural network 230 to a first synthetic image generated by training image generation neural network 205, and trains image generation neural network 230 is trained based on the comparison. Training component 250 is an example of, or includes aspects of, the corresponding element described with reference to FIGS. 8 and 11.

FIG. 3 shows an example of a training image generation neural network at inference time according to aspects of the present disclosure. The example shown includes training image mapping network 300, fully connected layer 305, intermediate latent space 310, training image generator 315, learned affine transform 320, learned per-layer scaling factors 325, first convolutional layer 330, second convolutional layer 335, and adaptive instance normalization 340. Training image mapping network 300 is an example of, or includes aspects of, the corresponding element described with reference to FIGS. 2 and 8. Training image generator 315 is an example of, or includes aspects of, the corresponding element described with reference to FIGS. 2 and 8.

The example shown in FIG. 3 represents a style-based GAN architecture. Specifically, FIG. 3 illustrates an example architecture of a training image generation neural network that has completed its training, and no longer includes global or region-specific discriminators. The architecture of a training image generation neural network at inference time is not necessarily limited to the example shown, however. The training image generation neural network may be implemented in any model which is capable of generating synthetic images that represent edits in one or more attributes.

In an example process, training image mapping network 300 performs a reduced encoding of the original input and the training image generator 315 generates, from the reduced encoding, a representation as close as possible to the original input. According to some embodiments, the training image mapping network 300 includes a deep learning neural network comprised of fully connected layers (e.g., fully connected layer 305). In some cases, the training image mapping network 300 takes a randomly sampled point from the latent space, such as intermediate latent space 310, as input and generates a latent vector as output. In some cases, the latent vector encodes style attributes in a style space referred to as W space. When the training image generation neural network is used to generate training data groups, the latent vector may be adjusted in one or more directions corresponding to one or more attributes, respectively, before being sent to training image generator 315. Additional detail regarding the training image generation process will be provided with reference to FIGS. 8-10.

According to some embodiments, the training image generator 315 includes a first convolutional layer 330 and a second convolutional layer 335. For example, the first convolutional layer 330 includes convolutional layers, such as a conv 3×3, adaptive instance normalization (AdaIN) layers, or a constant, such as a 4×4×512 constant value. For example, the second convolutional layer 335 includes an upsampling layer (e.g., upsample), convolutional layers (e.g., conv 3×3), and adaptive instance normalization (AdaIN) layers.

The training image generator 315 takes a constant value, for example, a constant 4×4×512 constant value, as input to start the image synthesis process. The latent vector generated from the training image mapping network 300 is transformed by learned affine transform 320 and is incorporated into each block of the training image generator 315 after the convolutional layers (e.g., conv 3×3) via the AdaIN operation, such as adaptive instance normalization 340. In some cases, the adaptive instance normalization layers can perform the adaptive instance normalization 340. The AdaIN layers first standardizes the output of feature map so that the latent space maps to features in a way so that a randomly selected feature map will result in features that are distributed with a Gaussian distribution, then add the latent vector as a bias term. This allows choosing a random latent variable and so that the resulting output will not bunch up. In some cases, the output of each convolutional layer (e.g., conv 3×3) in the training image generator 315 is a block of activation maps. In some cases, the upsampling layer doubles the dimensions of input (e.g., from 4×4 to 8×8) and is followed by another convolutional layer(s) (e.g., third convolutional layer).

According to some embodiments, Gaussian noise is added to each of these activation maps prior to the adaptive instance normalization 340. A different noise sample is generated for each block and is interpreted using learned per-layer scaling factors 325. In some embodiments, the Gaussian noise introduces style-level variation at a given level of detail.

FIG. 4 shows an example of an image generation neural network at inference time according to aspects of the present disclosure. The example shown includes input image 400, edit vector 405, encoder 410, decoder 415, mapping network 420, vector concatenation component 425, and modified image 430.

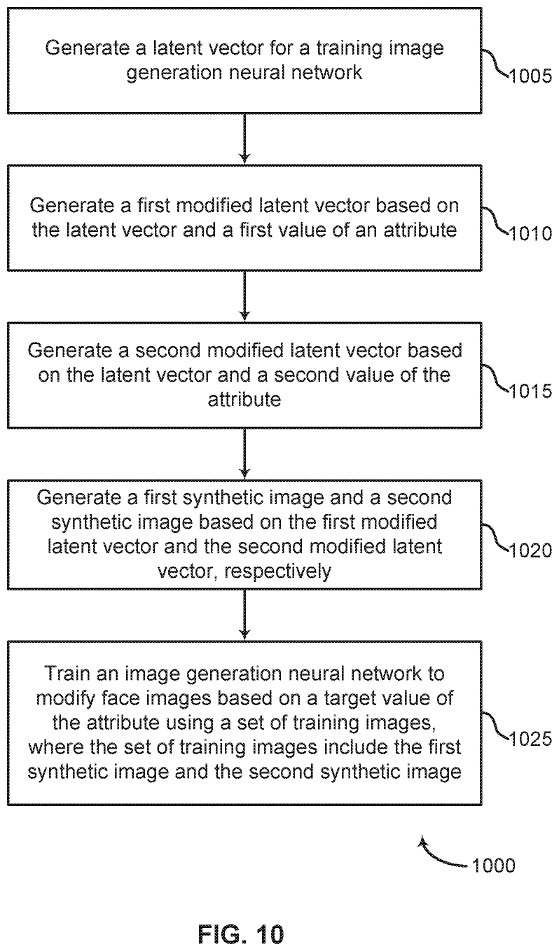

Edit vector 405 is an example of, or includes aspects of, the corresponding element described with reference to FIGS. 5 and 10. Encoder 410 and decoder 415 are examples of, or include aspects of, the corresponding elements described with reference to FIGS. 2, 5, and 11. Mapping network 420 is an example of, or includes aspects of, the corresponding element described with reference to FIGS. 2 and 11.

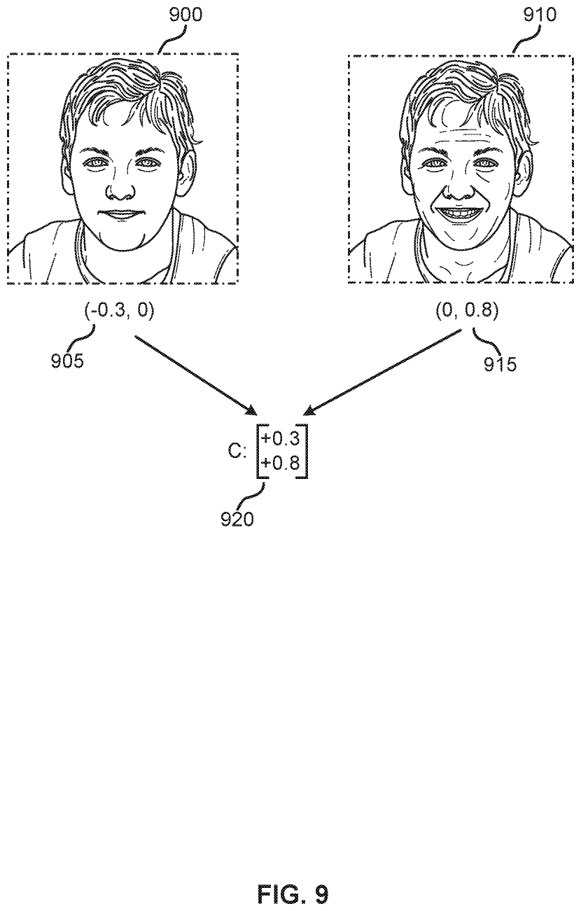

FIG. 4 illustrates both an architecture of an image generation neural network as well as a pipeline for editing multiple attributes of an input image. In this example, a user or an automated process provides input image 400, as well as identifies one or more attributes and changes thereto. The changes to the attributes are transformed into edit vector 405. In some examples, edit vector 405 is formed as {A₁, A₂, . . . Aₙ}, where Aᵢ is within the range [−1, 1], and includes a value of desired change to an attribute that the image generation neural network is configured to adjust, such as age, gender, smile, etc. In some embodiments, edit vector 405 contains a list of tuples, where each tuple includes both the value of the attribute to change, and a label for the attribute. An example of an edit vector is illustrated and described with reference to FIG. 9.

Encoder 410 transforms input image 400 into an intermediate representation referred to as an image embedding. In some examples, encoder 410 is a form of auto-encoder that includes connected layers. Encoder 410 learns to encode features from input images, as well as the relationships among the features. In some embodiments, encoder 410 includes a bottleneck structure that forces a compressed knowledge representation of input image 400, which enables the learning of inter-feature relationships. In some examples, encoder 410 passes this compressed representation to decoder 415, as illustrated by the connection in the center of FIG. 4. In at least one example, the image embedding is formed into the same dimensionality as a W style space. In some examples, encoder 410 passes one or more intermediate image embeddings, or portions of intermediate image embeddings, to decoder 415 through the utilization of skip connections. The skip connections are represented by the arrow above encoder 410 and decoder 415.

Mapping network 420 is configured to map a latent code from a Z space to another space, often referred to as W space, which disentangles style attributes of an image. This disentanglement allows for the editing of style attributes by moving the W space vector, also referred to as a latent vector, along various directions. In some cases, the latent code is based on noise from a distribution in Z space, and then the same noise information is mapped to the W space to form the latent vector. In an embodiment, edit vector 405 determines adjustments of the W space vector, which corresponds to the editing of one or more attributes. In at least one embodiment, the latent vector in W-space is computed once by mapping network 420 and then cached, such that mapping network 420 does not need to operate for every inference calculation. An example of such an embodiment is described with reference to FIG. 5.

Vector concatenation component 425 combines edit vector 405, the latent vector generated from mapping network 420, and the image embedding generated from encoder 410. Some conventional GANs operate unconditionally, wherein the generated image is based on the random noise vector from a mapping network and is reconstructed according to features learned from training data. In contrast, embodiments of the image generation neural network can generate images that include fine-texture and identity details from an input image such as input image 400. Vector concatenation component 425, in part, enables this functionality by combining features from the image embedding with edit vector 405 into a combined embedding to be processed by decoder 415. In some embodiments, vector concatenation component 425 includes multiple connected linear layers, and is configured to apply affine transformations to edit vector 405 and image embedding to produce a common dimensionality embedding. In some embodiments, the combined embedding is within the style W-space as described above. In some embodiments, the combined embedding is within another space referred to as S space, or StyleSpace, which disentangles attributes even further.

Decoder 415 is configured to generate modified image 430 based on the input image embedding and edit vector 405. In some examples, decoder 415 generates the image from a style-space combined embedding provided by vector concatenation component 425. In some embodiments, decoder 415 “borrows” several fine and coarse features from the input image embedding and from intermediate input image embeddings, which allows modified image 430 to preserve details from input image 400. Decoder 415 may use edit vector 405 to adjust a latent representation, or the adjustment may be applied through a matrix multiplication performed by vector concatenation component 425. In an example, decoder 415 transforms the edited latent vector from a style space such as W, W+, or S, to a pixel space, thereby generating modified image 430 which includes the edits specified by edit vector 405. Embodiments of decoder 415 are based on a guided CoModGAN decoder, and the decoding process can be similar to the synthesis process used by the style-based GAN generator as described with reference to FIG. 3.

A continuous editing process can incur several inference steps. In some cases, continuous editing can cause an image generation neural network to perform, for example, hundreds of inference steps with duplicated computations. Accordingly, some embodiments of the image generation neural network save computed values as cached feature tensors and cached style space tensors. In one example, this caching reduces inference time from 3.59 s±428 ms to 235 ms±2.69 ms per loop. In some cases, this enables the model to run on user devices such as a personal computer or a mobile phone.

FIG. 5 shows an example of an image generation neural network utilizing cached tensors according to aspects of the present disclosure. The example shown includes input image 500, edit vector 505, encoder 510, decoder 515, cached W vector 520, cached input image embedding 525, cached input image features 530, vector concatenation component 535, and modified image 540.

Input image 500 is an example of, or includes aspects of, the corresponding element described with reference to FIG. 4. Edit vector 505 is an example of, or includes aspects of, the corresponding element described with reference to FIGS. 4 and 10.

Encoder 510 and decoder 515 are examples of, or include aspects of, the corresponding elements described with reference to FIGS. 2, 4, and 11. Vector concatenation component 535 is an example of, or includes aspects of, the corresponding element described with reference to FIGS. 4 and 11.

FIG. 5 illustrates both an architecture and pipeline for editing multiple attributes of an input image. The example shown in FIG. 5 includes multiple cached tensors. Embodiments according to FIG. 5 may have reduced inference time, as the cached tensors including cached W vector 520, cached input image embedding 525, and cached input image features 530 do not need to be re-calculated for additional edits to an input image.

The process for editing multiple attributes of an input image according to the example shown in FIG. 5 is similar to the process illustrated in FIG. 4. Accordingly, the following description will focus on the differences between the two processes.

In an example, the system identifies input image 500 from a user or an automated process. Encoder 510 encodes input image 500 to produce an image embedding. The image embedding for the input image can be saved as cached input image embedding 525, and additional edits to input image may be based at least in part on cached input image embedding 525 without re-encoding input image 500. Additionally, various intermediate representations of input image 500 can be saved as cached input image features 530.

In some cases, a latent vector within a style space can be generated by a mapping network as described with reference to FIG. 3 or 4, and then saved and re-used as cached W vector 520. In some cases, cached W vector 520 corresponds to a noise vector within a style space as described with reference to FIG. 4. In some embodiments, cached W vector 520 is within another style space such as W+ or S space.

Vector concatenation component 535 combines edit vector 505 with cached W vector 520 and cached input image embedding 525 to form a combined embedding as input to decoder 515 similar to the combined input described with reference to FIG. 4. Decoder 515 generates modified image 540 in a process similar to the one described with reference to FIG. 4.

Accordingly, embodiments of an image generation neural network similar to the example shown in FIG. 5 can process an input image with greatly reduced inference time with respect to conventional models by caching feature tensors from the input image, as well as the style space vector. In an example, the feature tensors are cached only once per input image, and the cached style space vector is cached only once after the model is trained.

### Editing Multiple Facial Attributes

Synthetic images may be used to represent different values or intensities of a specific facial attribute, such as age, gender, or expression. In some examples, synthetic images generated by the training image generation neural network are used as part of the training data for the image generation neural network to learn to generate modified images with specific edited attributes.

A method for facial attribute editing is described. One or more aspects of the method include receiving input comprising an image of a face and a target value of an attribute of the face to be modified; encoding the image using an encoder of an image generation neural network to obtain an image embedding; and generating a modified image of the face having the target value of the attribute based on the image embedding using a decoder of the image generation neural network, wherein the image generation neural network is trained using a plurality of training images generated by a training image generation neural network, and wherein the plurality of training images includes a first synthetic image having a first value of the attribute and a second synthetic image depicting a same face as the first synthetic image with a second value of the attribute. In some aspects, the modified image preserves a texture of the image that is unrelated to the attribute. In some aspects, the modified image preserves an identity of the face.

Some examples of the method, apparatus, non-transitory computer readable medium, and system further include generating an edit vector that indicates the target value of the attribute, wherein the modified image is generated based on the edit vector. In some aspects, the edit vector indicates target values for a plurality of attributes of the face.

Some examples of the method, apparatus, non-transitory computer readable medium, and system further include generating a noise vector, wherein the modified image is generated based on the noise vector. Some examples further include providing an intermediate image embedding from the encoder as input to an intermediate layer of the decoder.

Some examples of the method, apparatus, non-transitory computer readable medium, and system further include caching the image embedding. Some examples further include receiving a subsequent input including an additional target value for an additional attribute to be modified. Some examples further include generating a subsequent modified image based on the cached image embedding and the additional target value. Detail regarding the generation of training data will be provided with reference to FIGS. 8-11.

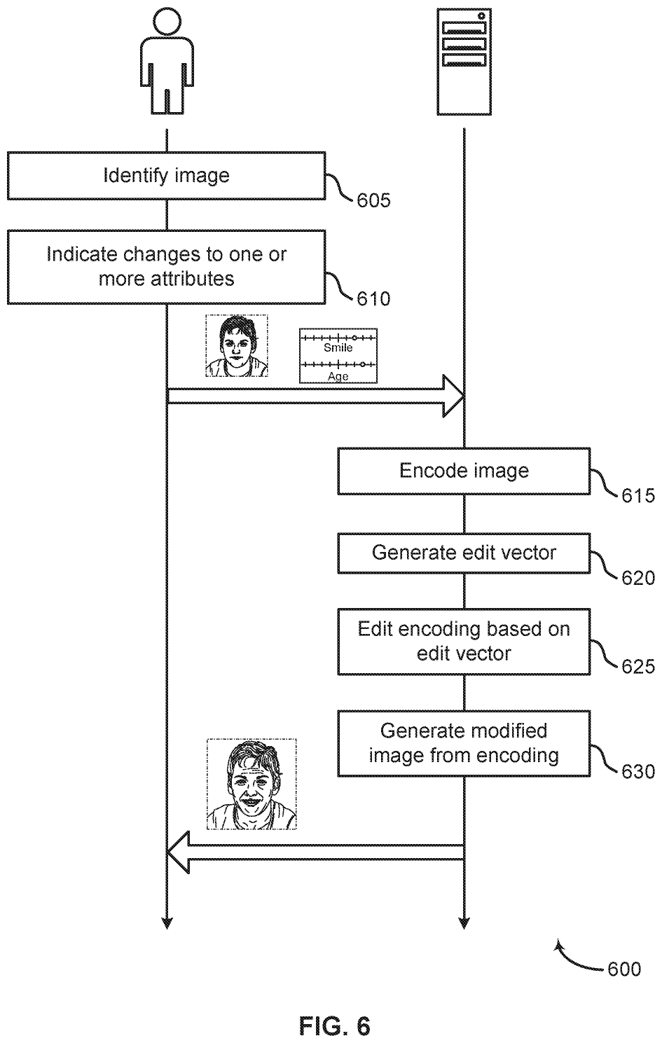

FIG. 6 shows an example of a method 600 for editing image attributes according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, a user identifies an image. The user may select an image using a graphical user interface (GUI), for example. In some cases, the GUI is included as part of image editing software or a web-app.

At operation 610, the user indicates changes to one or more attributes. For example, the user may use slider controls provided a GUI to indicate which attributes they desire to change, and the intensity of the changes. In some cases, the attributes include both positive and negative directions.

At operation 615, the system encodes the image. The system may encode the image using an encoder of an image generation neural network, such as the encoder described with reference to FIG. 4.

At operation 620, the system generates an edit vector. The edit vector may be created from the information provided by the user in operation 610. An example of an edit vector includes a sequence of values that represent desired changes to attributes of the image. In some examples, the values include positive and negative values between −1 and 1.

At operation 625, the system edits the encoding based on the edit vector. In an example, the encoding is a combined embedding within a style space that includes features from the input image. The combined embedding may be generated by a vector concatenation component as described with reference to FIG. 4. In some embodiments, the vector concatenation component performs a concatenation operation such as a matrix multiplication to 1) transform the image embedding into a style space and 2) adjust the image embedding within the style space.

At operation 630, the system generates modified image from the encoding. For example, a decoder of the image generation neural network may transform the edited encoding from a style space into a pixel space. The decoder may process the encoding similar to the process described with reference to FIG. 4. The system may then present the modified image to a user. In some cases, the system prompts the user for additional edits, or for re-generation of the image.

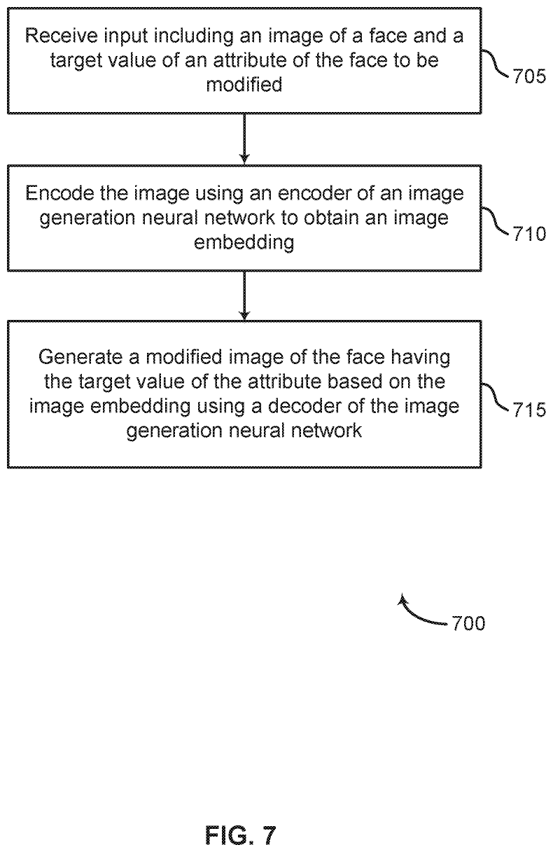

FIG. 7 shows an example of a method 700 for generating modified images according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system receives input including an image of a face and a target value of an attribute of the face to be modified. The “attribute” refers to a specific characteristic or feature of the face image that can be modified using the system. The “target value” refers to a desired adjustment value of a specific facial attribute that the user wants to modify in the input face image. The system enables the user to modify one or more attributes of the face image to achieve the desired result. For example, the attribute may be age, gender, or facial expression, and the target value may be a specific age, a specific gender, or a specific expression. In some examples, a target value may indicate the intensity of a modification. For example, for the attribute of a specific facial expression “smile,” a target value of “0.3” may indicate a more significant and noticeable smile than the face in the input image, while a target value of “−0.3” may indicate a less significant or noticeable smile than the face in the input image. In one example, a user provides the image through a user interface. In another example, the image is provided to the system based on an automatic process, such as a batch editing process.

At operation 710, the system encodes the image using an encoder of an image generation neural network to obtain an image embedding. In some cases, the encoder is an example of or similar to the encoders as described with reference to FIGS. 2, 4, 5, and 11.

At operation 715, the system generates a modified image of the face having the target value of the attribute by decoding the image embedding using a decoder of the image generation neural network, where the image generation neural network is trained using a set of training images generated by a training image generation neural network, and where the set of training images includes a first synthetic image having a first value of the attribute and a second synthetic image depicting a same face as the first synthetic image with a second value of the attribute. An example of the decoding process is provided with reference to FIG. 4. A training process for the image generation neural network is described with reference to FIGS. 10-11.

### Training

Embodiments of an image processing apparatus include two training phases. In an example, a training image generation neural network is trained during a first phase to learn to produce synthetic images. These synthetic images are then packaged as training groups for an image generation neural network. The image generation neural network is trained on the training groups during a second training phase, during which the image generation neural network learns to generate output image with multiple edited attributes based on the input image and an edit vector.

A method for facial attribute editing is described. One or more aspects of the method include generating a plurality of training images using a training image generation neural network, wherein the plurality of training images includes a first synthetic image having a first value of an attribute and a second synthetic image with a second value of the attribute and training an image generation neural network to modify face images based on a target value of the attribute using the plurality of training images. Some examples further include training the training image generation neural network based on a global discriminator and a region-specific discriminator.

Some examples of the method, apparatus, non-transitory computer readable medium, and system further include generating a latent vector for the training image generation neural network. Some examples further include generating a first modified latent vector based on the latent vector and the first value of the attribute, wherein the first synthetic image is generated based on the first modified latent vector. Some examples further include generating a second modified latent vector based on the latent vector and the second value of the attribute, wherein the second synthetic image is generated based on the second modified latent vector. Some examples further include generating a third modified latent vector based on the latent vector and a third value of the attribute. Some examples further include generating a third synthetic image based on the third modified latent vector.

Some examples of the method, apparatus, non-transitory computer readable medium, and system further include identifying a modification basis vector corresponding to the attribute. Some examples further include multiplying the modification basis vector by the first value of the attribute to obtain a latent modification vector, wherein the first modified latent vector is based on the latent modification vector.

In some aspects, the first value of the attribute comprises a positive value and the second value of the attribute comprises a negative value. In some aspects, the plurality of training images includes additional synthetic images generated based on a plurality of additional attributes.

Some examples of the method, apparatus, non-transitory computer readable medium, and system further include generating a modified image based on the first value of the attribute using the image generation neural network. Some examples further include comparing the modified image to the first synthetic image, wherein the image generation neural network is trained based on the comparison.

FIG. 8 shows an example of a training image generation neural network during a first training phase according to aspects of the present disclosure. The example shown includes training image mapping network 800, training image generator 805, synthetic image 810, global discriminator 815, region-specific discriminator 820, and training component 825. Training component 825 is an example of, or includes aspects of, the corresponding element described with reference to FIGS. 2 and 11.

Training image mapping network 800 is an example of, or includes aspects of, the corresponding element described with reference to FIGS. 2 and 3. Training image generator 805 is an example of, or includes aspects of, the corresponding element described with reference to FIGS. 2 and 3.

Global discriminator 815 is an example of, or includes aspects of, the corresponding element described with reference to FIG. 2. Region-specific discriminator 820 is an example of, or includes aspects of, the corresponding element described with reference to FIG. 2.

In an example first training phase, a training image mapping network 800 such as the one described with reference to FIG. 3 creates a noise vector and maps it to a style space to create a latent vector. Then training image generator 805 generates synthetic image 810 by transforming the latent vector into a pixel space. Some embodiments of training image generator include progressive growing layers, which generate output images at successively higher resolutions throughout the training process.

Global discriminator 815 is configured to classify the output from training image generator 805 as real or fake. In an example, global discriminator 815 is presented with both output images from training image generator 805 and real images from a body of training data. The goal of global discriminator 815 is to determine whether the current image is from the set of real images, or an output from training image generator 805. The result of this determination is input to training component 825. When global discriminator 815 incorrectly classifies an image, training component 825 computes a classification loss and updates parameters of global discriminator 815 based on the classification loss. In this way, global discriminator 815 is iteratively improved.

Region-specific discriminator 820 operates similarly to global discriminator 815, except in that region-specific discriminator 820 is configured to evaluate a subset of pixels output from training image generator 805. In some embodiments, this region corresponds to a mouth on a face. A bounding box region may be dynamically determined using various computer vision techniques, or may be set to a constant region under the assumption that the mouth of a person within the synthetic and real images will not move between images. In some cases, the use of region-specific discriminator 820 during the first phase training process causes training image generator 805 to produce higher-quality teeth textures. Region-specific discriminator 820 may be iteratively improved in a similar way to global discriminator 815 through the use of training component 825.

Once the training of the training image generation neural network is completed, the model can be used to generate training data groups. In some cases, the architecture of the training generation neural network is not able to edit multiple attributes of an input image, but is instead well-suited to generate editable synthetic images. This may be due to the inherent “reconstruction-editability tradeoff” described above. Accordingly, embodiments utilize the training image generation neural network to prepare training data that is used to train an image generation neural network to learn to edit multiple attributes of an input image.

The following describes an example process for synthetic data preparation using a trained training image generation neural network such as the one described with reference to FIG. 3. In one example, a style space of the training image generation neural network includes K different disentangled attributes. The corresponding latent directions in the style space for each attribute can be represented as dw₁, dw₂, . . . , dw_{K}. Accordingly, adjusting an image embedding within this style space by moving the embedding in a direction i will adjust an attribute that corresponds to i.

N different bases for training groups are sampled from random latent codes z₁, z₂, . . . , z_{N}. A mapping network such as the one described with reference to FIG. 3 then maps the latent codes to latent vectors w₁, w₂, . . . , w_{N} within a style space, such as W space. For each wᵢ and each latent editing direction dwₖ, embodiments sample alpha within the range (0, 1) and generate three images: G(wᵢ−α*dwₖ), G(wᵢ), G(wᵢ+α*dwₖ). These images correspond to absolute scores −α, 0, and +α for the k-th attribute. In some cases, the images are evaluated according to a perceptual loss to determine suitable bounds for −α and +α for each attribute. Accordingly embodiments of a training image generation neural network generate triplets for each random latent code for each latent editing direction. Training data groups are not necessarily formed in triplets. For example, FIG. 9 illustrates a training data group that includes a first image with a first set of attributes, a second image with a second set of attributes, and an edit vector that describes an attribute delta between the first and second sets of attributes.

FIG. 9 shows an example of training data generated by a training image generation neural network according to aspects of the present disclosure. The example shown includes base synthetic image 900, first attribute value(s) 905, edited synthetic image 910, second attribute value(s) 915, and edit vector 920.

In some examples, base synthetic image 900 from a sampled random latent code z₁ that has been translated to a style space and then into a generated image using a mapping network and a generator of a training image generation neural network. Such a process is described in greater detail with reference to FIG. 3. In some cases, base synthetic image 900 includes an attribute that has been altered from z₁. In the illustrated example, first attribute value(s) 905 of base synthetic image 900 are (−0.3, 0), which indicates an initial shift in the negative direction of a smile attribute.

Edited synthetic image 910 is also produced by the training image generation neural network. In this example, edited synthetic image 910 includes second attribute value(s) 915, which are (0, 0.8). With respect to base synthetic image 900, this represents a change of +0.3 for the smile attribute, and +0.8 for an age attribute. This attribute delta is computed dynamically and scored in a corresponding edit vector 920 as [+0.3, +0.8]. In one embodiment, a training group of the form (X₁, C₁, Y₁) is created, where X₁ is base synthetic image 900, C₁ is edit vector 920, and Y₁ is edited synthetic image 910.

FIG. 10 shows an example of a method 1000 for generating synthetic images according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system generates a latent vector for a training image generation neural network. In some cases, the operations of this step refer to, or may be performed by, a training image mapping network as described with reference to FIGS. 2, 3, and 8. The latent vector may be in a style space that disentangles attributes of an image, such as attributes corresponding to a face. Some examples of the latent vector are based on a random sampling of latent code from a z space, as described with reference to FIG. 9.

At operation 1010, the system generates a first modified latent vector based on the latent vector and a first value of an attribute. In some cases, the operations of this step refer to, or may be performed by, a training image mapping network as described with reference to FIGS. 2, 3, and 8. For example, the system may “move” the latent vector in a certain direction by editing values of the vector corresponding to that direction.

At operation 1015, the system generates a second modified latent vector based on the latent vector and a second value of the attribute. In some cases, the operations of this step refer to, or may be performed by, a training image mapping network as described with reference to FIGS. 2, 3, and 8. The process for generating the second modified latent vector may be similar to the process for generating the first modified latent vector.

At operation 1020, the system generates a first synthetic image and a second synthetic image based on the first modified latent vector and the second modified latent vector, respectively. In some cases, the operations of this step refer to, or may be performed by, a training image generator as described with reference to FIGS. 2, 3, and 8.

At operation 1025, the system trains an image generation neural network to modify face images based on a target value of the attribute using a set of training images, where the set of training images include the first synthetic image and the second synthetic image. In some cases, the operations of this step refer to, or may be performed by, a training component as described with reference to FIGS. 2, 8, and 11. The system may train the image generation neural network based on a pixel based loss such as an L2 loss. In some embodiments, the training component includes additional loss aspects such as adversarial loss, path-length regularization, and R1 regularization.

FIG. 11 shows an example of an image generation neural network during a second training phase according to aspects of the present disclosure. The example shown includes training data 1100, encoder 1105, decoder 1110, vector concatenation component 1115, mapping network 1120, predicted image 1125, training component 1130, and loss function 1135.

Encoder 1105 is an example of, or includes aspects of, the corresponding element described with reference to FIGS. 2, 4, and 5. Decoder 1110 is an example of, or includes aspects of, the corresponding element described with reference to FIGS. 2, 4, and 5.

Vector concatenation component 1115 is an example of, or includes aspects of, the corresponding element described with reference to FIGS. 4 and 5. Mapping network 1120 is an example of, or includes aspects of, the corresponding element described with reference to FIGS. 2 and 4. Training component 1130 is an example of, or includes aspects of, the corresponding element described with reference to FIGS. 2 and 8.

FIG. 11 illustrates both the architecture of an image generation neural network as well as a pipeline for training the image generation neural network during a second training phase. The second training phase updates parameters of the image generation neural network, and enables the model to edit multiple attributes of an image at once during inference.

In an example, training data 1100 including training data groups (Xᵢ, Cᵢ, Yᵢ) is provided to an encoder 1105. The goal of the training process is to teach the image generation neural network to generate a modified image Yᵢ for a given input image Xᵢ and edit vector Cᵢ. Referring to FIG. 9, for example, image generation neural network learns to generate an image that is close to edited synthetic image 910 based on base synthetic image 900 and edit vector 920. For example, once the training process is completed, the image generation neural network will be able to increase both smile and age attributes with respect to an input image such as base synthetic image 900 based on an edit vector including positive values for those attributes.

Encoder 1105 creates an image embedding of an input image Xᵢ that encodes features and inter-feature relationships of the input image. The edit vector Cᵢ is provided to vector concatenation component 1115, and combined with the image embedding as well as a style-space vector produced by mapping network 1120 to form a combined vector. In at least one example, the style-space vector is computed by mapping network 1120 once and used for the remainder of the second phase of training. In some cases, mapping network 1120 is iteratively trained along with the remaining components of the image generation neural network. The combined vector including information from the style-space vector, the image embedding, and the edit vector is sent to decoder 1110 which then generates predicted image 1125.

Training component 1130 compares predicted image 1125 to the modified image included in the training data, e.g., modified image Yᵢ. Training component 1130 then computes loss function 1135 based on the differences between predicted image 1125 and the modified image from the training data. In some examples, loss function 1135 includes an L2 loss. In some cases, loss function 1135 includes other losses and regularization means such as adversarial loss, path-length regularization, and R1 regularization. Then, the parameters of each component in the image generation neural network are iteratively adjusted for each training data group according to loss function 1135.

In this way, an image generation neural network is trained to edit multiple attributes of an input image. The image generation neural network can edit multiple attributes within one inversion of the input image into a style-space, and is further configured to edit the attributes along a continuous range of intensities. The architecture of the image generation neural network, such as skip connections between encoder 1105 and decoder 1110, enables the image generation neural network to transfer fine details and textures from the input image to the output image, thereby enabling multiple-attribute editing with identity preservation. Some embodiments of the image generation neural network further include cached tensors, which increase computation speed at inference.

FIG. 12 shows an example of a computing device 1200 according to aspects of the present disclosure. The example shown includes computing device 1200, processor(s), memory subsystem 1210, communication interface 1215, I/O interface 1220, user interface component(s), and channel 1230.

In some embodiments, computing device 1200 is an example of, or includes aspects of, image processing apparatus 100 of FIG. 1. In some embodiments, computing device 1200 includes one or more processors 1205 that can execute instructions stored in memory subsystem 1210 to receive input comprising an image of a face and a target value of an attribute of the face to be modified; encode the image using an encoder of an image generation neural network to obtain an image embedding; and generate a modified image of the face having the target value of the attribute based on the image embedding using a decoder of the image generation neural network.

According to some aspects, computing device 1200 includes one or more processors 1205. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1215 operates at a boundary between communicating entities (such as computing device 1200, one or more user devices, a cloud, and one or more databases) and channel 1230 and can record and process communications. In some cases, communication interface 1215 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1220 is controlled by an I/O controller to manage input and output signals for computing device 1200. In some cases, I/O interface 1220 manages peripherals not integrated into computing device 1200. In some cases, I/O interface 1220 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1220 or via hardware components controlled by the I/O controller.

According to some aspects, user interface component(s) 1225 enable a user to interact with computing device 1200. In some cases, user interface component(s) 1225 include an audio device, such as an external speaker system, an external display device such as a display screen, an input device (e.g., a remote control device interfaced with a user interface directly or through the I/O controller), or a combination thereof. In some cases, user interface component(s) 1225 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
receiving input comprising an image of a face and a target value of an attribute of the face to be modified;
encoding the image using an encoder of an image generation neural network to obtain an image embedding; and
generating a modified image of the face having the target value of the attribute based on the image embedding using a decoder of the image generation neural network, wherein the image generation neural network is trained using a plurality of training images generated by a training image generation neural network, and wherein the plurality of training images includes a first synthetic image having a first value of the attribute and a second synthetic image depicting a same face as the first synthetic image with a second value of the attribute.

2. The method of claim 1, further comprising:
generating an edit vector that indicates the target value of the attribute, wherein the modified image is generated based on the edit vector.

3. The method of claim 2, wherein:
the edit vector indicates target values for a plurality of attributes of the face.

4. The method of claim 1, further comprising:
generating a noise vector, wherein the modified image is generated based on the noise vector.

5. The method of claim 1, further comprising:
providing an intermediate image embedding from the encoder as input to an intermediate layer of the decoder.

6. The method of claim 1, wherein:
the modified image preserves a texture of the image that is unrelated to the attribute.

7. The method of claim 1, wherein:
the modified image preserves an identity of the face.

8. The method of claim 1, further comprising:
caching the image embedding;
receiving a subsequent input including an additional target value for an additional attribute to be modified; and
generating a subsequent modified image based on the cached image embedding and the additional target value.

9. A method comprising:
generating a plurality of training images using a training image generation neural network, wherein the plurality of training images includes a first synthetic image having a first value of an attribute and a second synthetic image with a second value of the attribute; and
training an image generation neural network to modify face images based on a target value of the attribute using the plurality of training images.

10. The method of claim 9, further comprising:
generating a latent vector for the training image generation neural network;
generating a first modified latent vector based on the latent vector and the first value of the attribute, wherein the first synthetic image is generated based on the first modified latent vector; and
generating a second modified latent vector based on the latent vector and the second value of the attribute, wherein the second synthetic image is generated based on the second modified latent vector.

11. The method of claim 10, further comprising:
generating a third modified latent vector based on the latent vector and a third value of the attribute; and
generating a third synthetic image based on the third modified latent vector.

12. The method of claim 10, further comprising:
identifying a modification basis vector corresponding to the attribute; and
multiplying the modification basis vector by the first value of the attribute to obtain a latent modification vector, wherein the first modified latent vector is based on the latent modification vector.

13. The method of claim 9, wherein:
the first value of the attribute comprises a positive value and the second value of the attribute comprises a negative value.

14. The method of claim 9, wherein:
the plurality of training images includes additional synthetic images generated based on a plurality of additional attributes.

15. The method of claim 9, further comprising:
training the training image generation neural network based on a global discriminator and a region-specific discriminator.

16. The method of claim 9, further comprising:
generating a modified image based on the first value of the attribute using the image generation neural network; and
comparing the modified image to the first synthetic image, wherein the image generation neural network is trained based on the comparison.

17. An apparatus comprising:
at least one processor;
at least one memory including instructions executable by the at least one processor; and
an image generation neural network configured to generate a modified image of a face having a target value of an attribute based on an image embedding, wherein the image generation neural network is trained using a plurality of training images including a first synthetic image having a first value of the attribute and a second synthetic image depicting a same face as the first synthetic image with a second value of the attribute.

18. The apparatus of claim 17, wherein:
the image generation neural network includes an encoder and a decoder, and wherein an intermediate layer of the encoder provides input to an intermediate layer of the decoder.

19. The apparatus of claim 17, further comprising:
a training image generation neural network configured to generate the plurality of training images.

20. The apparatus of claim 19, wherein:
the training image generation neural network comprises a global discriminator and a region-specific discriminator.
